(19) United States
(12) Patent Application Publication
(10) Pub. No.: US 2006/0094481 A1
(43) Pub. Date: May 4, 2006

(54) Earphone and microphone adapter

(76) Inventor: Steven M. Gullickson, Victoria (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/263,367

(22) Filed: Oct. 31, 2005

(30) Foreign Application Priority Data
Nov. 1, 2004 (CA) 2,483,439

(51) Int. Cl. H04M 1/00

(52) U.S. Cl. 455/575.2

(57) ABSTRACT

An earphone and microphone adapter consists of a housing, with a cellular telephone interface on the housing connecting a cellular telephone with an audio circuit. Audio input to the audio circuit received via the cellular telephone interface passes through the audio circuit to an earphone interface where it can be heard by a user. Audio input to the audio circuit received via a microphone interface passes through the audio circuit to the cellular telephone interface where it can be heard by a remote listener.

### FIELD OF INVENTION

The present invention relates to an adapter, and in particular to apparatus and method to facilitate the proper connection and operation of broadcast quality lavalier microphones and in-ear audio clarifiers, commonly used in the television industry, to the hands-free socket of a cellular telephone or analog land line device that accepts an external 2.5 mm universal earphone/microphone set.

### BACKGROUND OF THE INVENTION

The current practice in the television industry is for the camera operator to use a cell phone breakout box. The cell phone break out box consists of a medium sized suitcase in which the cellular telephone is placed in a cradle and a plug inserted into the hands free socket. The incoming signal is then connected to a wireless IFB transmitter. The television reporter and the camera operator wear the associated wireless receivers on the waist, which allows them to connect broadcast quality industry standard in ear audio clarifiers. The reporter and the camera operator are able to hear the IFB audio signal from the television station over a cellular telephone using a high quality, discreet and comfortable in ear audio clarifier designed to present a professional image and built to withstand the rigors of remote broadcasting. The disadvantages of the aforementioned cell phone breakout box are the size, expense and A/C power requirements for a wireless transmitter. By using only one cellular telephone for the IFB signal from the television station both the camera operator and the reporter share the same audio feed. This limits the effectiveness of the communication between the control room of the television studio and the remote site because the director can't speak to the camera operator or reporter individually. For example when the reporter is on-air the director can't relay additional commands to the camera operator because the on-air reporter would hear the same thing and possibly become distracted by these instructions and loose their train of thought on while on-air. While the cell phone breakout box allows the camera operator and the reporter to hear the IFB audio signal from the television studio, if a camera operator wants to talk back to the control room they must depress a switch and speak into a microphone located at the cell phone breakout box. This can limit a camera operator's ability to move to far from the cell phone breakout box, or cause delays in responding to the control room in a business where seconds count.

### SUMMARY OF THE INVENTION

According to the present invention there is provided an earphone and microphone adapter that enables an audio input received via a cellular telephone to be heard in an earphone worn by a user, while permitting an audio input received via a microphone to be communicated to the cellular telephone where it can be heard by a remote listener.

### BRIEF DESCRIPTION OF THE DRAWINGS

FIG. 1A PRIOR ART is a diagram showing a conventional hands free earphone/microphone set.

FIG. 1B PRIOR ART is a diagram showing the electrical connections within the earphone/microphone set as shown in FIG 1A.

FIG. 2 PRIOR ART is a diagram showing a cell phone break out box.

FIG. 3A is a diagram of the front view of the present invention according to the first preferred embodiment.

FIG. 3B is a diagram of the rear view of the present invention according to the first preferred embodiment.

FIG. 4 is a diagram of an Audio Implements ear piece

FIG. 5 is a diagram of a Sony ECM-77B lavalier microphone.

FIG. 6 is a diagram showing a Sony ECM-77B microphone, a Audio Implements ear piece, a cellular telephone with a hands free socket and the present invention according to the first preferred embodiment.

FIG. 7 is a circuit diagram showing the electrical connections within the adapter and associated plug according to the first preferred embodiment.

### DESCRIPTION OF PRIOR ART

Telephone calls are normally conducted while holding a handset or cellular phone with one hand to the side of the head. This can sometimes make it difficult or possibly dangerous for a user to continue working or driving with just one hand free for the duration of the call. Therefore most mobile telephones and many analog landline devices have a socket for connecting an external hands free earphone/microphone set. Conventional hands free earphone/microphone sets typically consist of a headset or earpiece that rests on the head or outer ear and a microphone that must be placed near the mouth of the user.

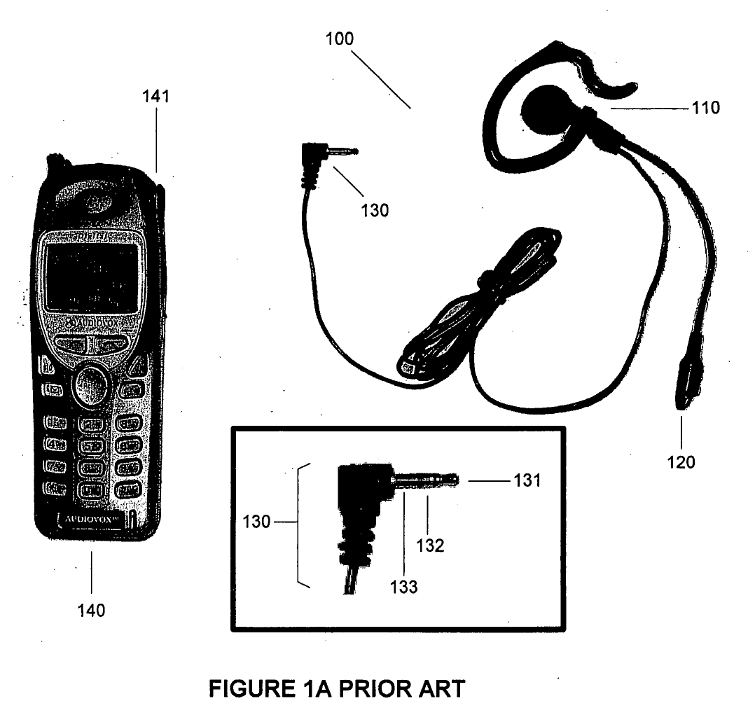

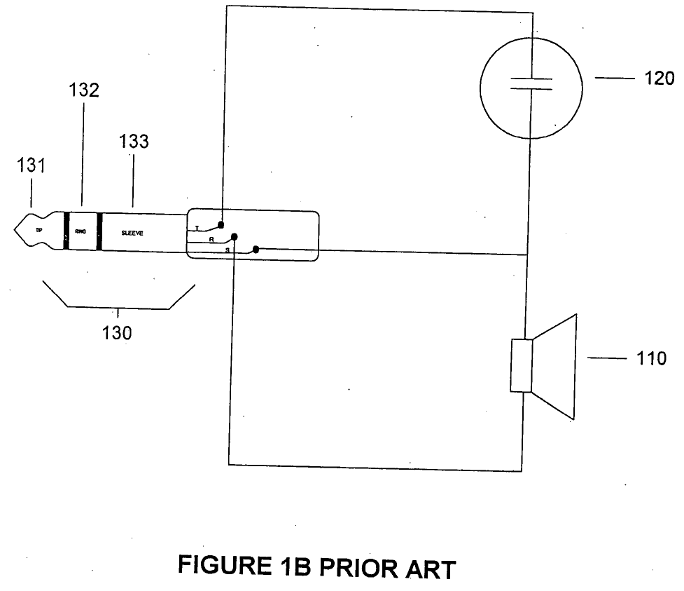

FIG. 1A is a drawing of a mobile cellular telephone and a conventional earphone/microphone set.

FIG. 1B is a circuit diagram illustrating the electrical connections of FIG. 1A.

As shown in FIGS. 1A & 1B the earphone microphone 100 set consists of an earpiece 110, a microphone 120, and a 2.5 mm plug 130. The plug 130 contains 3 terminals 131, 132, and 133. One end of the earphone 110 is connected to terminal 132 of plug 130 while the other end of the earphone is connected to terminal 133 of plug 130. One end of the microphone is connected to terminal 131 of the plug 130 while the other end of the microphone is connected to terminal 133 of the plug 130. The plug 130 fits into the hands free socket 141 of a mobile cellular telephone 140. The hands free socket 141 has internal contact points for connecting with the three corresponding terminals of the plug 130. When the plug 130 is plugged into the socket 141, the external microphone 120 and earphone 110 are connected to the internal circuit of the mobile cellular phone 140. Once the plug 130 is connected to the mobile cellular phone 140 the user can place the earphone 110 onto one's ear. The microphone 120 is placed so it is close to the users mouth when the earphone 110 is placed on the ear. The user can then have both hands free for the duration of the telephone call. Although the aforementioned conventional earphone/microphone set 100 allows most users to continue working or driving with a greater degree of safety, there are some professions whose needs are not being met by the variety of conventional earphone/microphone sets 100 currently available. For example a camera operator and a reporter working at a remote location during a live television broadcast. Television broadcasting is normally conducted from a production studio within a television station. During a live newscast from the studio it is often desired to broadcast a signal that originates from a remote location. Examples include weather reports, sporting events; traffic updates and live news coverage. The camera operator and reporter at the remote location listen to the audio signal from the television studio over a mobile cellular telephone or landline device. In the television industry this audio signal is referred to as fold back and is usually the voice of a news anchor at the news desk in the television studio introducing and asking questions to the reporter in the field. This fold back audio signal can also be interrupted by the director in the television studio control room to deliver real time instructions to the remote camera operator and or the reporter about how to frame a shot or how many seconds a reporter has to wrap up their report. In the television industry this audio signal fed from the television studio to the remote site is known as an IFB line for interrupt fold back. Mobile cellular telephones 140 and landline devices are used everyday to facilitate the communication between television studios and remote location sites yet camera operators and reporters are reluctant to use the aforementioned conventional style of hands free earphone/microphone sets 100. Camera operators find the fit and quality of conventional hands free earphone/microphone sets 100 troublesome because the earphone pieces 110 are uncomfortable to wear for a long period of time or tend to require constant adjusting to keep from falling out of the ear. Conventional hands free microphones 120 often hang from the earpiece 110 or are attached to a mini boom arm that clips over the ear or head of the user. The microphone 120 which must be placed near the mouth of the user can also interfere with the camera operator's ability to position their face tight to the camera body and viewfinder. Camera operators are sometimes required to put on a second set of headphones to temporarily listen to the incoming audio signal from the reporter going into his equipment, this task is awkward to perform when using a conventional hands free earphone/microphone set 100. Television reporters who appear live from remote locations during a news broadcast are reluctant to use conventional earphone/microphone sets 100 for cellular IFB communication because not only do they find the earpieces 110 uncomfortable, but the microphone 120 which must be placed near the users mouth makes for an awkward appearance on the television screen at home which can compromise the image the reporter is trying to achieve in their presentation.

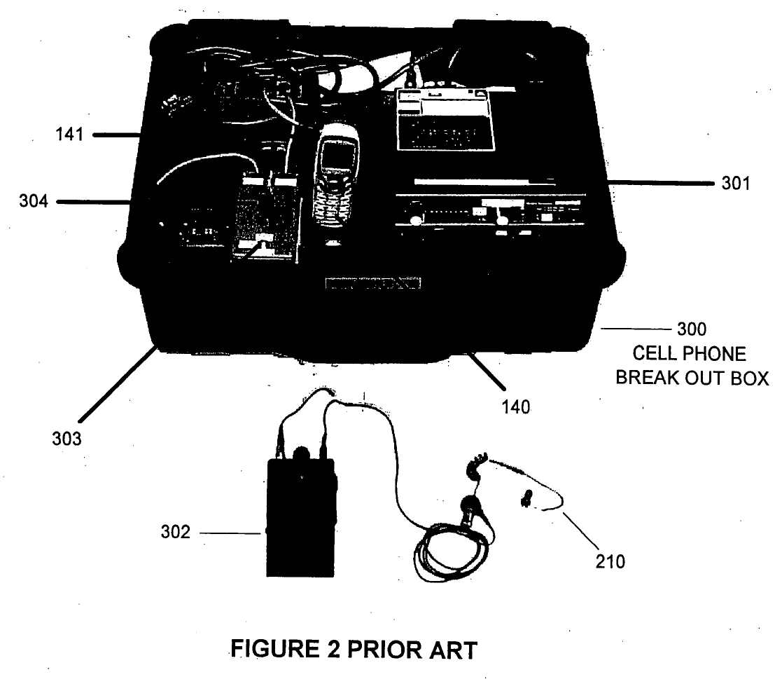

To overcome the aforementioned problems and limitations of conventional hands free earphone/microphone sets 100, one current practice in the television industry is for the camera operator to use a cell phone breakout box. Referring to FIG. 2 the cell phone break out box 300 consists of a medium sized suitcase in which the cellular telephone 140 is placed in a cradle and a plug inserted into the hands free socket 141. The incoming signal is then connected to a wireless IFB transmitter 301 such as that made by Shure Bros. The television reporter and the camera operator wear the associated wireless receivers 302 on the waist, which allows them to connect broadcast quality industry standard in ear audio clarifiers 210 such as those made by Audio Implements. The advantage of this system is that the reporter and the camera operator are able to hear the IFB audio signal from the television station over a cellular telephone using a high quality, discreet and comfortable in ear audio clarifier designed to present a professional image and built to withstand the rigors of remote broadcasting. The disadvantages of the aforementioned cell phone breakout box 300 are the size, expense and A/C power requirements for a wireless transmitter 301, and by using only one cellular telephone 140 for the IFB signal from the television station both the camera operator and the reporter share the same audio feed. This limits the effectiveness of the communication between the control room of the television studio and the remote site because the director can't speak to the camera operator or reporter individually. For example when the reporter is on-air the director can't relay additional commands to the camera operator because the on-air reporter would hear the same thing and possibly become distracted by these instructions and loose their train of thought on while on-air. While the cell phone breakout box 300 allows the camera operator and the reporter to hear the IFB audio signal from the television studio, if a camera operator wants to talk back to the control room they must depress a switch 303 and speak into a microphone 304 located at the cell phone breakout box 300. This can limit a camera operator's ability to move to far from the cell phone breakout box 300, or cause delays in responding to the control room in business where seconds count. Hence the aforementioned cell phone breakout box 300 and conventional hands free earphone/microphone sets 100 are not ideal for this application. In light of the foregoing there is a need for an adapter to improve hands free cellular communication in the television broadcast industry.

### DESCRIPTION OF THE PREFERRED EMBODIMENTS

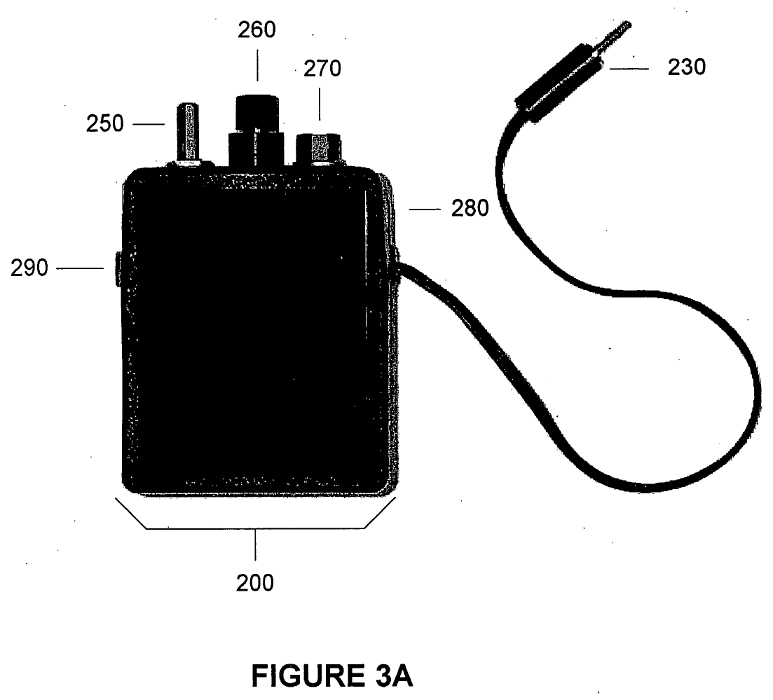

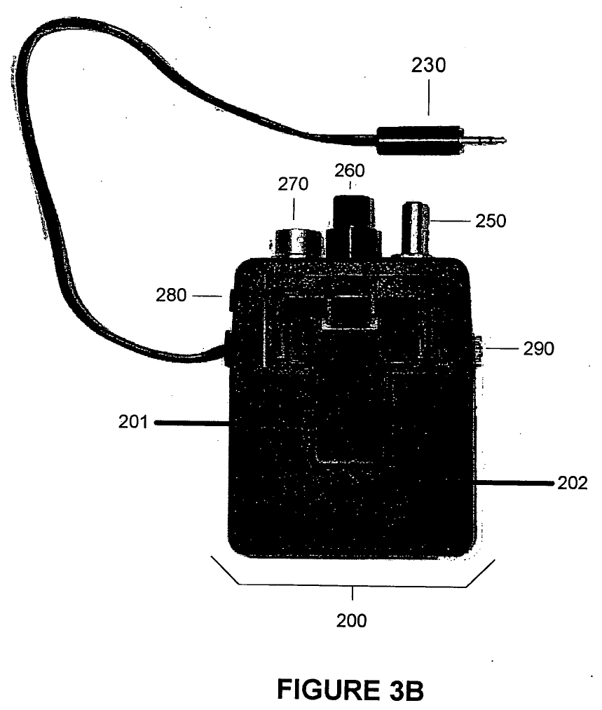

With reference to the drawings and, in particular, with reference to FIGS. 3A & B, the apparatus of the present invention is comprised of a small plastic electronic enclosure, indicated generally at 200, housing a 3.5 mm earpiece jack 290, a volume potentiometer 250, a push to talk switch 260 and a microphone receptacle 270. The volume pot 250 has a power on/off switch and a power on indicator is provided in the form of a light emitting diode 280. The plastic enclosure body features a belt clip 201, and an easy access battery door 202. The enclosed printed circuit board 400 and a nine-volt battery are not shown. A 2.5 mm plug 230 along with a length of three-conductor cable is provided for electrical mating between the printed circuit board 400 enclosed within the adapter body 200 and the hands free socket of a cellular telephone. The plug 230 provides the electrical connection between the adapter 200 and the internal contacts of the cellular phone.

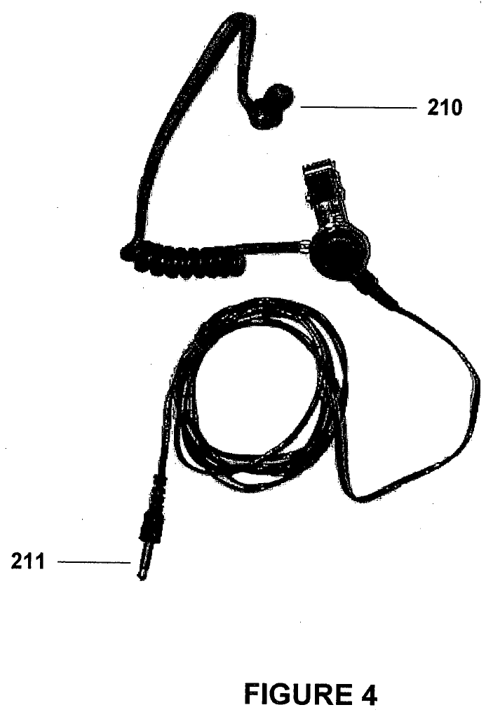

Referring to FIGS. 3A and 4, the earpiece jack 290 is a 3.5 mm mono chassis jack mounted to the apparatus body 200. The jack 290 is utilized to connect an external broadcast quality audio clarifier 210 such as that made by Audio Implements. Audio Implements has supplied in ear audio clarifiers to the television broadcasting industry for over 20 years. As shown in FIG. 4 the in ear audio clarifier consists of a 3.5 mm mono plug 211 attached by a length of cable to the earpiece 210. The audio clarifier comes with seven different sizes of ear tips that can be quickly changed to fit different sized ears.

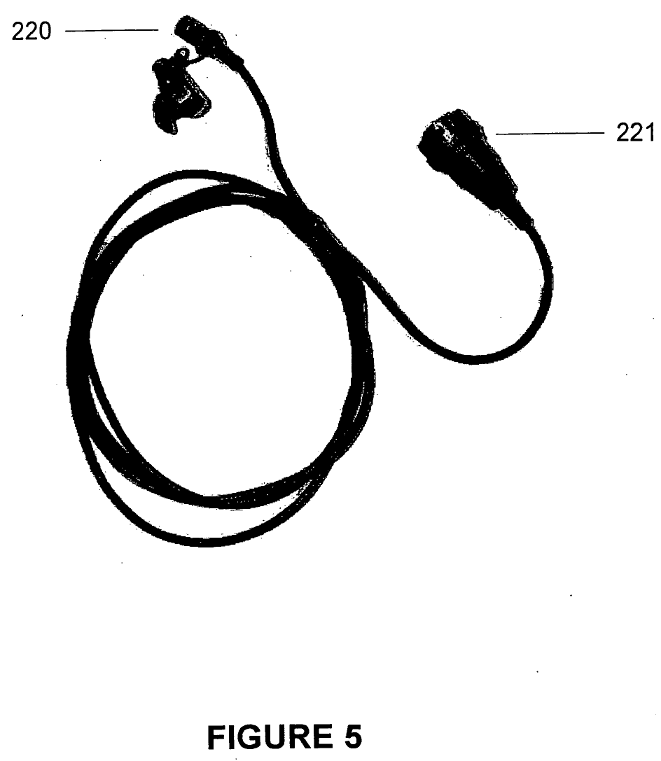

Audio Implements also supplies custom molded earpieces made from an impression of the individual users ear. Referring to FIGS. 3A and 5, the microphone receptacle 270 mounted on the apparatus body 200 is a 9 mm bayonet lock connector made by Hirose Electric Ltd. The microphone receptacle 270 is utilized to facilitate the proper connection and operation of a broadcast quality lavalier microphone 220 such as an ECM-77B made by Sony Ltd. As shown in FIG. 5 the lavalier microphone consists of a plug 221 attached by a length of cable to the microphone 220. A broadcast quality lavalier microphone such as an ECM-77B, 220 is designed to deliver a high quality voice signal while being worn on the chest of the user. Sony Electronics is a major supplier of lavalier microphones normally used for wireless applications in the television broadcast industry.

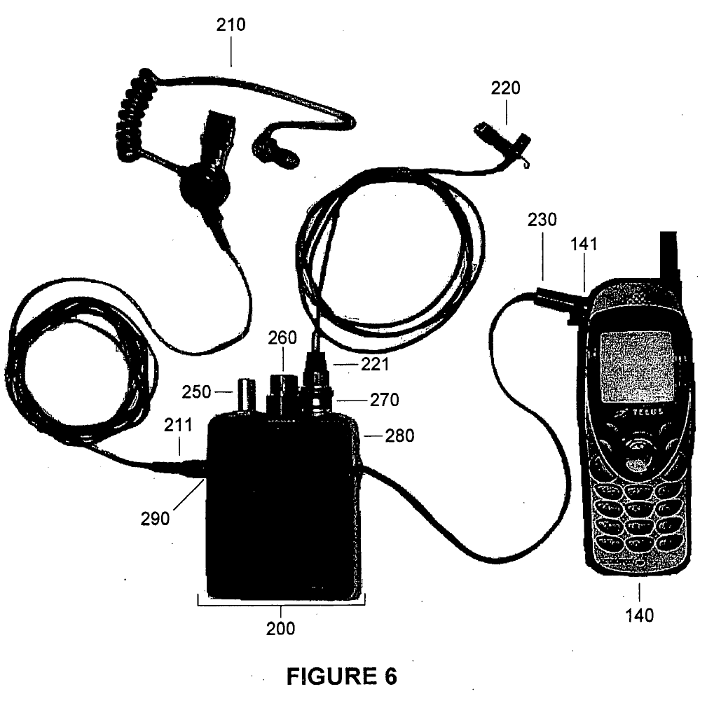

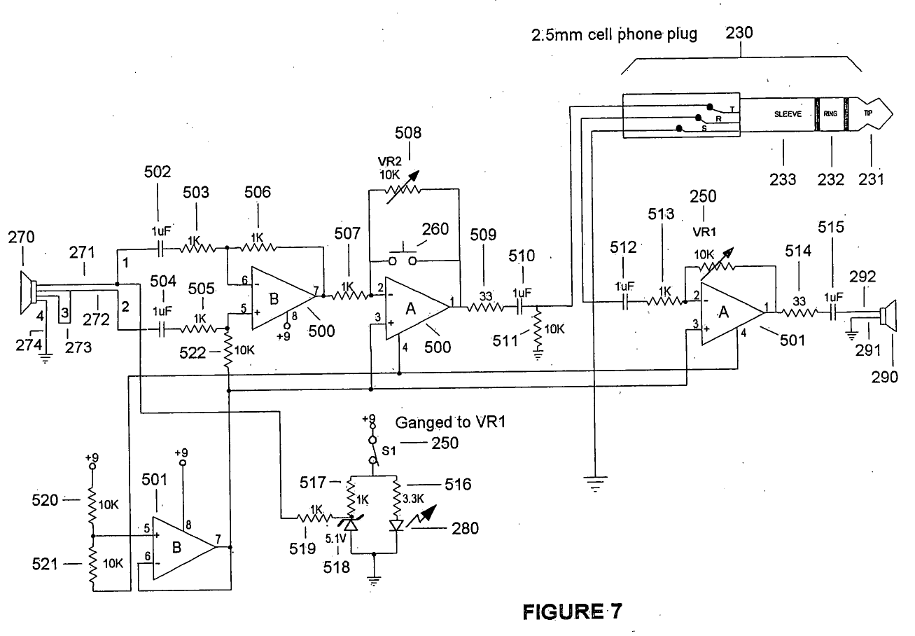

The aforementioned microphone 220 and in ear audio clarifier 210 are not supplied with the adapter 200 but are readily available at most television stations and require no modifications for use with the present adapter 200. FIG. 6 is a diagram showing a Sony ECM-77B lavalier microphone 220, an Audio Implements in ear audio clarifier 210, a cellular telephone 140 with a hands free socket 141, and the present adapter 200 according to the first preferred embodiment. In advance of using the present adapter, the adapter body 200 is attached to the users hip by the supplied belt clip 201. The microphone 220 is attached to the users chest and the wire dressed or concealed in clothing. The attached plug 221 is inserted into the microphone receptacle 270 mounted on the adapter body 200. The earpiece 210 is inserted into the users ear and the wire dressed or concealed in clothing. The attached plug 211 is inserted into the 3.5 mm chassis jack 290 mounted on the apparatus body 200. Once a cellular telephone call has been established the user can insert the 2.5 mm plug 230 into the hands free socket 141 of the mobile cellular phone 140. The mobile cellular phone 140 will recognize the adapter 200 as a headset and disable its internal microphone and speaker. The cellular telephone 140 can then be attached to the waist of the user with a belt clip next to the adapter body 200. Thereby, when in use, the adapter 200 can transmit the voice signals from the external microphone 220 to the mobile cellular telephone 140 via the tip 231 of the plug 230. Pressing the on/off switch 260 mounted on the adapter body 200 mutes the voice signal from the microphone 220. The received signals from the mobile cellular phone are linked to the printed circuit board 400 enclosed within the adapter body 200 via the ring 232 of the plug 230 and directed to the in ear audio clarifier 210. The potentiometer knob 250 mounted on the adapter body 200 controls the volume of the received signal being fed to the earpiece 210. Hence once a cellular connection has been established and the plug 230 inserted into the hands free socket 141 the present adapter 200 as so described provides a hands free system for communicating over a cellular connection without handling the cellular phone 140 for the duration of the call. Similarly, the electrical and mechanical features of the adapter 200 enable the user to maximize the benefits of adapting a broadcast quality earpiece 210 and lavalier style microphone 220 for use in hands free cellular communication. As depicted in FIG. 7, and according to the first preferred embodiment, the supplied microphone receptacle 270 is a 9 mm bayonet lock connector made by Hirose Electric Ltd. The microphone receptacle 270 contains four terminals 271, 272, 273, 274. Terminals 272 and 273 are connected by a wire. Terminal 274 is connected by a wire to the ground plane of the printed circuit board 400. Terminal 271 is connected by a wire to the printed circuit board and the signal directed thru a 1 uF capacitor 502, and a 1 K resistor 503, to pin 6 of a dual low noise operational amplifier, 500-B such as a NE5532 produced by Texas Instruments. Pins 1-4 of the operational amplifier are depicted at 500-A, and pins 5-8 at 500-B. Terminal 272 of the microphone receptacle 270 is connected by a wire to the printed circuit board 400 and the signal directed thru a 1 uF capacitor 504, and a 1K resistor 505, to pin 5 of the operational amplifier 500-B. A 1K resistor 506 is connected between pin 7 and pin 6 of the operational amplifier 500-B. A 1K resistor 507 is connected between pin 7 and pin 2 of the dual low noise operational amplifier 500-A. A 10K variable resistor 508 is connected between pin 1 and pin 2 of the dual low noise operational amplifier 500-A. The user can adjust the variable resistor 508, with a small screwdriver to optimize the output level of the external lavaliere microphone 220. This can improve the voice quality by minimizing the effect of the automatic gain control circuitry within the mobile cellular telephone 140. A push on/off switch 260 is connected between pin 1 and pin 2 of the operational amplifier 500-A. The push on/off switch 260 allows the user to mute the output of the microphone 220. Consequently the user is free to talk to someone nearby without having to worry about being overheard by someone on the telephone, and the intercom system in the control room of the television station is free of unwanted background noise from the remote location. The output of the dual low noise operational amplifier 500-A is directed via pin 1 thru a 33 ohm resistor 509 and a 1 uF capacitor 510. The signal is then directed to a common point with one path passing thru a 10K resistor 511 to ground, and a second path attached by a wire to the tip 231 of the 2.5 mm plug 230. The incoming signal of the mobile cellular phone 140 is connected by a wire from the ring 232 of the plug 230 to the printed circuit board 400 and directed thru a 1 uF capacitor 512, a 1K resistor 513 and into pin 2 of a second dual low noise operational amplifier 501. Pins 1-4 are indicated at 501-A and pins 5-8 are indicated at 501-B. A 10K volume potentiometer 250 is connected between pin 1 and pin 2 of the operational amplifier 501-A. The output of the operational amplifier 501-A is directed via pin 1 thru a 33 ohm resistor 514 and a 1 uF capacitor 515. The signal is then connected by a wire to terminal 292 of the 3.5 mm earpiece jack 290. Terminal 291 of the jack 290 and the terminal 233 of the plug 230 are both connected by a wire to the ground plane of the printed circuit board. The operational amplifier 501-A provides gain to the received signal from the mobile cellular phone 140 while the potentiometer 250 allows the user to control the volume level directed to the earpiece via the 3.5 mm chassis jack 290. The positive terminal of a 9 volt battery is connected by a wire to the normally open terminal of the on/off switch within the potentiometer 250. The negative terminal of the 9-volt battery is connected by a wire to the ground plane of the printed circuit board 400. The normally closed terminal of the on/off switch within the potentiometer 250 is connected by a wire to the power plane of the printed circuit board 400. A path of 9-volts dc is directed thru a 3.3K resistor 516 and connected to the positive terminal of a light emitting diode 280. The second terminal of the LED 280 is connected by a wire to ground. The user is thus provided with a visual indicator of the on/off status and battery strength of the present adapter 200. Another path of 9-volts dc is directed thru a 1K resistor 517 to the positive polarity of a 5.1 volt zener diode 518, with the other end connected to ground. The 5.1 volts is then directed thru a 1K resistor 519 and connected by a wire to terminal 271 of the microphone receptacle 270. Thus the present adapter 200 as so described provides the microphone receptacle 270 and supplies the voltage required to facilitate the proper connection and operation of a broadcast quality lavalier microphone such as a Sony ECM-77B 220. With further reference to FIG. 7 a path of 9-volts dc is directed to pin 8 of both dual low noise operational amplifiers indicated at 500-B and 501-B. Another path of 9-volts dc is directed thru a 10K resistor 520 to common point, with one of the paths directed to pin 5 of the operational amplifier 501-B and the other thru a second 10K resistor 521 and directed to pin 4 of both dual operational amplifiers indicated at 500-A and 501-A. Pin 6 and 7 of the operational amplifier 501-B are directed to a common point with one of the paths directed to pin 3 of both operational amplifiers indicated at 500-A and 501-A, and the other path directed thru a 10K resistor 522 to pin 5 of operational amplifier 500-B According to a second preferred embodiment a series TB5M connector made by Switchcraft Ltd. is substituted in place of the 9 mm bayonet lock microphone receptacle made by Hirose Electric Ltd, indicated at 270 in the drawings. With reference to FIG. 7 and substituting the Switchcraft TB5M microphone receptacle at 270 the pin assignment would be as follows, pin 1 of the Switchcraft TB5M is connected to ground as indicated at 274, pin 2 is connected to the path indicated at 271, and pin 3 to the path indicated at 272. A wire is connected between pins 3 and 4. Pin 5 is not used. The aforementioned Switchcraft TB5M microphone receptacle mates to the plug commonly found attached to lavalier microphones used with wireless transmitters made by Lectrosonics Ltd. Lectrosonics wireless microphone transmitters and receivers are widely used in the television production industry and accommodate lavalier microphones from a variety of manufacturers including Sennhieser, Voice Technologies and Sony. By supplying two versions of the present adapter 200, the first using a 9 mm bayonet lock connector made by Hirose Electric Ltd as the microphone receptacle indicated at 270 in the drawings and the second providing the Switchcraft TB5M as the microphone receptacle 270, the present adapter 200 is compatible with the majority of broadcast quality lavalier microphones used in the television production industry. The aforementioned lavalier microphones require no modifications for use with the present adapter. The purpose of the present invention is to improve hands free cellular telephone communication in the television broadcast industry by providing an adapter that allows workers in the field to utilize readily available industry standard earpieces 210 and lavalier microphones 220 that are superior in fit and function to those supplied with a conventional earphone/microphone set 100. With reference to FIG. 6, an example of the intended use of the present adapter would be maintaining a cellular IFB connection between the control room of a television studio and a camera operator and a reporter working at a remote location during a live television newscast. In advance of establishing the cellular connection, the camera operator would attach the adapter 200 to the waist with the supplied belt clip 201. The lavalier microphone 220 is attached to the chest area and the in ear audio clarifier 210 is inserted into the ear. The wires can be dressed or concealed in clothing in such a manner as not to impede movement, and the plugs 221 and 211 are inserted into the receptacles 270 and 290 provided by the adapter 200. Once a cellular connection has been established by hand, the user can insert the supplied 2.5 mm plug 230 into the hands free socket 141 of the cell phone 140. The cell phone 140 can then be placed on the hip next to the present invention 200. The external lavalier microphone 220 and in ear audio clarifier 210 are now electrically mated to the internal electrical contacts of the cell phone. The user is thus able to have both hands free for the duration of the call.

The present invention relates to an adapter, and in particular to apparatus and method to facilitate the proper connection and operation of broadcast quality lavalier microphones and in-ear audio clarifiers commonly used in the television broadcasting industry to the hands free socket of a mobile cellular telephone or analog land line device that accepts an external 2.5 mm universal earphone/microphone set. The purpose of the invention is to improve hands free cellular telephone communication in the television broadcasting industry by providing an adapter that allows workers in the field to utilize readily available industry standard ear pieces and microphones that are superior in fit and function to those supplied in a conventional hands free earphone/microphone set.

To achieve these and other advantages and in accordance with the purpose of the invention, as embodied and broadly described herein, the invention provides a 9 mm bayonet lock microphone receptacle that mates to the plug commonly found attached to a lavalier style microphone such as an ECM-77B made by Sony Ltd. Broadcast quality lavalier microphones are normally used for wireless microphone applications in the television broadcast industry. Unlike a conventional earphone/microphone set 100 where the microphone must be placed close to the users mouth, a lavalier style microphone such as a Sony ECM-77B is designed to deliver a high quality voice signal while being worn on the chest. According to another aspect of the invention there is provided a 3.5 mm earpiece receptacle that mates with the plug found attached to an audio clarifier such as that made by Audio Implements. Audio Implements has supplied custom molded in ear audio clarifiers to all the major networks in the television broadcasting industry for over 20 years. The user is thus able to benefit from listening to the incoming audio from the cellular telephone with a high quality, discreet and comfortable in ear audio clarifier built to withstand the rigors of remote broadcasting. In addition to the foregoing attributes the present adapter possesses numerous other electrical and mechanical benefits over the aforementioned cell phone break out box 300 and conventional hands free earphone/microphone sets 100. Mechanical features of the adapter include a push to talk switch that allows the user to mute the lavalier microphone at the touch of the switch and a rotary potentiometer with an on-off switch to adjust the volume of the incoming audio signal being fed from the cellular telephone to the in ear audio clarifier. Electrical features of the adapter include utilizing a first operational amplifier to provide gain to the incoming audio signal from the cell phone being directed to the in ear audio clarifier. The adapter also utilizes a second audio operational amp for microphone gain and a variable resistor that the user can adjust with a screwdriver to optimize the output level of the external microphone going into the cellular telephone. Moreover the present invention also supplies the voltage required to power a broadcast quality lavalier style microphones such as that made by Sony, Lectrosonics, and Sennhieser.

The aforementioned microphone receptacle, earpiece receptacle, volume pot and push to talk switch along with the printed circuit board and nine volt battery are all housed within a small plastic enclosure worn on the hip of the user. According to another aspect of the invention there is provided a 2.5 mm plug and a length of three-conductor cable for electrical mating between the adapter and the hands free socket of a cellular telephone. When the 2.5 mm plug is inserted into the hands free socket the cell phone will recognize the present invention as a headset and disable its internal microphone and speaker. The external broadcast quality lavalier microphone and in ear audio clarifier are now electrically mated to the internal electrical contacts of the cell phone. The user is thus able to have both hands free for the duration of the call. The present invention solves several problems associated with using conventional hands free earphone/microphone sets 100 or a cell phone breakout box 300 for cellular communication in the television broadcasting industry. Camera operators find the fit and quality of conventional hands free earphone/microphone sets troublesome because the earpieces are uncomfortable and require too much adjusting to keep in place. In addition the microphone that must be placed near the users mouth can get in the way when positioning their face tight to the camera body and viewfinder. The present invention overcomes these problems by providing an adapter that enables the camera operator to utilize a lavalier microphone such as a Sony ECM-77B, that is designed to deliver a high quality voice signal while being worn on the chest. The operator is thus able to avoid the situation of a microphone placed close to the mouth interfering with the operation of the camera. The microphone and wire can be concealed in the clothing in such a manner as not to impede movement thereby avoiding the situation of becoming entangled in a wire. There is also provided a push on/off switch to mute the microphone when it is not in use to minimize unwanted noise in the intercom system back at the television station. The present adapter enables the operator to utilize an in ear audio clarifier such as that made by Audio Implements. This provides the operator with the benefit of being able to hear the IFB audio signal from the television studio over a cellular telephone using a high quality, discreet and comfortable custom molded earpiece built to withstand the rigors of remote broadcasting.

This affords the operator an increased level of confidence in maintaining the vital communication link with the television studio control room and avoids the problem of using an uncomfortable earpiece that requires constant adjustment. Since the camera operator is now wearing a microphone on the chest and a cell phone on the hip next to the present adapter they no longer have to stay near or make their way back to the cell phone break out box to respond to a question from the control room. The operator is able to respond immediately by simply depressing the supplied push to talk switch. The operator is thus able to realize the benefit of increased mobility in the performance of their duties and the control room benefits from an immediate response when directing a question to a camera operator in the field. It can thus be seen that the present invention provides a novel adapter that is ideally suited for the preceding application.

In conclusion the adapter of this invention 200 in combination with a broadcast quality lavalier microphone 220 and in ear audio clarifier 210 provides at least the following advantages for hands free cellular communication in the television broadcast Industry:
1. The adapter 200 provides the dc voltage and the microphone receptacle 270 to facilitate the proper connection and operation of industry standard broadcast quality lavalier microphones such as Sony, Lectrosonics, Sennhieser and Voice Technologies with no modifications required.
2. Unlike a conventional earphone/microphone set 100 where the microphone 120 must be placed near the users mouth, lavalier microphones are designed to deliver a high quality voice signal while being worn on the chest. The camera operator is thus able to avoid the situation of a microphone placed close to the mouth interfering with the operation of the camera or having to stay close to the cell phone breakout box 300 to respond to questions from the studio
3. The adapter 200 provides gain circuitry that can be adjusted by the user with a small screwdriver to optimize the output level of the microphone 220. This can improve voice quality on the receiving end of the cellular connection by minimizing the undesirable effects of the automatic gain control circuitry within the cellular telephone.
4. The push on/off switch 260 mutes the output of the microphone when not in use.

Consequently the user is free to talk without having to worry about being overheard, and the intercom system in the control room is free of unwanted noise from the remote location
5. The adapter provides an earpiece receptacle 290 to accommodate the connection of a broadcast quality in ear audio clarifier such as that made by Audio Implements. The operator is thus able to hear the cellular IFB audio signal from the television station using a high quality discreet and comfortable in ear audio clarifier designed to withstand the rigors of remote broadcasting.
6. The adapter 200 provides gain circuitry to increase the level of the incoming audio signal from the cell phone 140 and a rotary potentiometer with an on/off switch to adjust the volume of the signal directed to the earpiece.
7. If the camera operator and reporter were both to be equipped with the current adapter 200, a cell phone 140, an earpiece 210, and a microphone 220, the director in the control room of the television station would be able to issue important instructions separately to either the camera operator or the reporter during a remote broadcast and the need for a cell phone breakout box 300 would be eliminated. This would not only improve communication between the control room and the remote site but would save valuable set up time, minimize the demand for A/C power and save the expense of the wireless IFB transmitter 301 and receivers 302.

In light of the above description, a number of advantages of the present invention are apparent. Preferably the adapter 200 works with any cellular telephone equipped with a universal 2.5 mm hands free jack that accepts a generic third party headset 100. Although the invention has been described in connection with preferred embodiments, it should be understood that various modifications, additions and alterations may be made to the invention by one skilled in the art without departing from the spirit and scope of the invention as defined in the following claims.

What is claimed is:

1. An earphone and microphone adapter, comprising:
a housing approximately the same size as a cellular telephone;
an audio circuit housed in the housing;
a battery power source positioned within the housing and adapted to provide power input into the audio circuit;
a microphone interface on the housing adapted to provide audio input into the audio circuit, while providing power input from the audio circuit to a microphone;
an earphone interface on the housing adapted to provide audio output from the audio circuit to an earphone;
a cellular telephone interface on the housing adapted to connect a cellular telephone with the audio circuit so that audio input to the audio circuit received via the cellular telephone interface passes through the audio circuit to the earphone interface where it can be heard by a user and audio input to the audio circuit received via the microphone interface passes through the audio circuit to the cellular telephone interface where it can be heard by a remote listener.

2. The earphone and microphone adapter as defined in claim 1, wherein the audio circuit includes means to amplify the audio input from the cellular telephone.

3. The earphone and microphone adapter as defined in claim 1, wherein the audio circuit includes means to amplify the audio input from the microphone.

4. The earphone and microphone adapter as defined in claim 1, wherein an on and off switch is provided to selectively turn on and off audio input received by the audio circuit via the microphone interface.

5. The earphone and microphone adapter as defined in claim 1, wherein means are provided for manually adjusting a volume of the audio output going from the audio circuit to the earphone interface.

6. The earphone and microphone adapter as defined in claim 1, wherein means are provided for manually adjusting microphone input gain.

7. The earphone and microphone adapter as defined in claim 1, wherein the earphone interface is a 3.5 mm chassis jack.

8. The earphone and microphone adapter as defined in claim 1, wherein the microphone interface is adapted to receive a lavalier-style microphone.

9. The earphone and microphone adapter as defined in claim 1, wherein means are provided for mounting the housing to a body of the user.

10. The earphone and microphone adapter as defined in claim 9, wherein the means for mounting the housing to a body of the user is a belt clip.

11. An earphone and microphone adapter, comprising:
a housing approximately the same size as a cellular telephone;
an audio circuit housed in the housing;
a battery power source positioned within the housing and adapted to provide power input into the audio circuit;
a microphone interface on the housing adapted to adapted to receive a lavalier-style microphone and provide audio input into the audio circuit, while providing power input from the audio circuit to the microphone;
an on and off switch to selectively turn on and off audio input received by the audio circuit via the microphone interface;
an earphone interface on the housing adapted to provide audio output from the audio circuit to an earphone;
an adjustment knob for manually adjusting a volume of the audio output going from the audio circuit to the earphone interface;
a cellular telephone interface on the housing adapted to connect a cellular telephone with the audio circuit so that audio input to the audio circuit received via the cellular telephone interface passes through the audio circuit to the earphone interface where it can be heard by a user and audio input to the audio circuit received via the microphone interface passes through the audio circuit to the cellular telephone interface where it can be heard by a remote listener; and
operational amplifiers in the audio circuit to amplify the audio input from the cellular telephone and amplify the audio input from the microphone.

12. The earphone and microphone adapter as defined in claim 11, wherein a manually adjustable variable resistor is provided on the audio circuit for manually adjusting microphone input gain.

13. The earphone and microphone adapter as defined in claim 11, wherein a belt clip is secured to the housing whereby the housing is mounted to a body of the user.

14. The earphone and microphone adapter as defined in claim 11, wherein the earphone interface is a 3.5 mm chassis jack.
